(19) United States
(12) Patent Application Publication
(10) Pub. No.: US 2023/0227332 A1
(43) Pub. Date: Jul. 20, 2023

(54) WATER TREATMENT PITCHER

(71) Applicant: Sodastream Industries Ltd., Kfar Saba (IL)

(72) Inventors: Allan RING, Mercaz Shapira (IL); Avraham COHEN, Tel-Aviv (IL); Alon WAISMAN, Shoham (IL); Gur VALDISLAV, Modi'in (IL)

(73) Assignee: Sodastream Industries Ltd., Kfar Saba (IL)

(21) Appl. No.: 17/578,454

(22) Filed: Jan. 19, 2022

(51) Int. Cl. C02F 1/32; C02F 1/00

(52) U.S. Cl. CPC C02F 1/32; C02F 1/003; C02F 1/008; C02F 2303/04; C02F 2307/04; C02F 2201/326

(57) ABSTRACT

A water treatment pitcher includes a portable container, with a cover to and a filling inlet, and a spout for dispensing filtered water. The pitcher has an upper water basin inside the portable container for receiving water, having a filter seat for a filter. The water basin allows the filtered water to drip into and be collected in a space of the container that is lower with respect to the filter when the container is upright; and an ultraviolet (UV) generator configured to radiate UV radiation from a UV emitter on the water collected in the space and to radiate UV radiation from the UV emitter onto the filtered water as it drips from an outlet of the upper water basin to the space of the container that is lower with respect to the filter.

### FIELD OF THE INVENTION

The present invention relates to water treatment. More particularly, the present invention relates to a water treatment pitcher.

### BACKGROUND OF THE INVENTION

Water may contain various kinds of contaminants—physical contaminants, such as, sediment or organic matter (e.g., suspended in the water), chemical contaminants, (e.g., compounds or compositions of matter), biological contaminants (e.g., organisms) and even radiological contaminants (e.g., unstable atoms emitting ionizing radiation).

Water treatment is typically aimed at removing the contaminants by using a filtering medium acting to serve as a physical harrier and/or perform chemical process and/or biological process.

There are various types of water filters, such as, water pitcher filters, faucet filters, countertop filters, under-sink filters, whole house filters and reverse-osmosis filtering systems.

A water treatment pitcher typically has a removable filter and is designed to filter water poured into the pitcher. The filtered water drains through the removable filter into a lower part of the pitcher, where it is held until it is dispensed. The removable filter is typically designed to filter a predetermined volume of water and needs to be replaced periodically.

Filters of water treatment pitchers are typically designed to perform physical filtering and or chemical filtering

It may be desired to provide a water treatment pitcher that is also configured to inactivate biological contaminants for the treated water.

### SUMMARY OF THE INVENTION

There is thus provided, in accordance with an embodiment of the invention, a water treatment pitcher. The water treatment pitcher may include a portable container, with a cover to cover a top opening of the container, the cover comprising a filling inlet, the container having a spout for dispensing filtered water. The water treatment pitcher may also include an upper water basin inside the portable container for receiving water introduced through the filling inlet, having a filter seat to accommodate a filter, to filter water in the upper water basin, the upper water basin configured to allow the filtered water to drip into and be collected in a space of the container that is lower with respect to the filter when the container is upright. The water treatment pitcher may also include an ultraviolet (UV) generator configured to radiate UV radiation from a UV emitter on the water collected in the space and to radiate UV radiation from the UV emitter onto the filtered water as it drips from an outlet of the upper water basin to the space of the container that is lower with respect to the filter

According to some embodiments of the present invention, the water treatment pitcher also includes a tilt sensor, and wherein the UV generator is further configured to radiate UV radiation from the UV emitter when the tilt sensor detects that the pitcher is tilted.

According to some embodiments of the present invention, shape and position of the upper water basin and the UV when placed within the pitcher define a passage from within the space of container towards the spout, having an inlet adjacent to the UV emitter and an outlet adjacent to the spout.

According to some embodiments of the present invention, the UV generator is configured to radiate UV radiation only when installed inside the pitcher and when the cover fully covers the top opening of the container.

According to some embodiments of the present invention, the UV generator, when installed inside the pitcher, is juxtaposed to the upper water basin.

According to some embodiments of the present invention, the cover is removable.

According to some embodiments of the present invention, the filter is replaceable.

According to some embodiments of the present invention, the water treatment pitcher may further include a safety disabling mechanism to disable the UV generator from generating UV radiation when the UV generator is not positioned in an intended position inside the pitcher.

According to some embodiments of the present invention, the safety disabling mechanism includes at least one pair of a magnetic sensor and a magnet.

According to some embodiments of the present invention, the magnetic sensor is a Hall Effect sensor.

According to some embodiments of the present invention, the UV generator is slidingly engageable to a side wall of the upper water basin.

According to some embodiments of the present invention, the UV generator comprises an elongated housing with a groove and the side wall of the upper water basin comprises a column, and wherein the groove is configured to fit over the column.

According to some embodiments of the present invention, the water treatment pitcher may include a display for displaying one or a plurality of indications.

According to some embodiments of the present invention, the display is located on a top surface of the UV generator.

According to some embodiments of the present invention, the UV generator comprises a rechargeable battery.

According to some embodiments of the present invention, the UV generator comprises a charging port.

According to some embodiments of the present invention, the charging port comprises a USB socket or a magnetic charging connector.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is a general view of a water treatment pitcher, according to some embodiments of the present invention.

FIG. 2A is a cross-sectional view of a water treatment pitcher, according to some embodiments of the present invention.

FIG. 2B shows the cover of a water treatment pitcher, according to some embodiments of the present invention, with a magnet holder holding a magnet of a safety disabling mechanism.

FIG. 2C is a partial view of the spout area of a water treatment pitcher, according to some embodiments of the present invention, with a magnet holder holding a magnet of a safety disabling mechanism.

FIG. 2D illustrates details of the filling lid of a cover of a water treatment pitcher, according to some embodiments of the present invention.

FIG. 2E is a partial top view through the top opening into the container of a water treatment pitcher, according to some embodiments of the present invention.

FIG. 2F is a partial top view a cover of a water treatment pitcher, according to some embodiments of the present invention.

FIG. 3 illustrates dispensing filtered water from the water treatment pitcher, according to some embodiments of the present invention.

FIG. 4 illustrates an ultraviolet (UV) generator for use in a filter pitcher, according to sonic embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

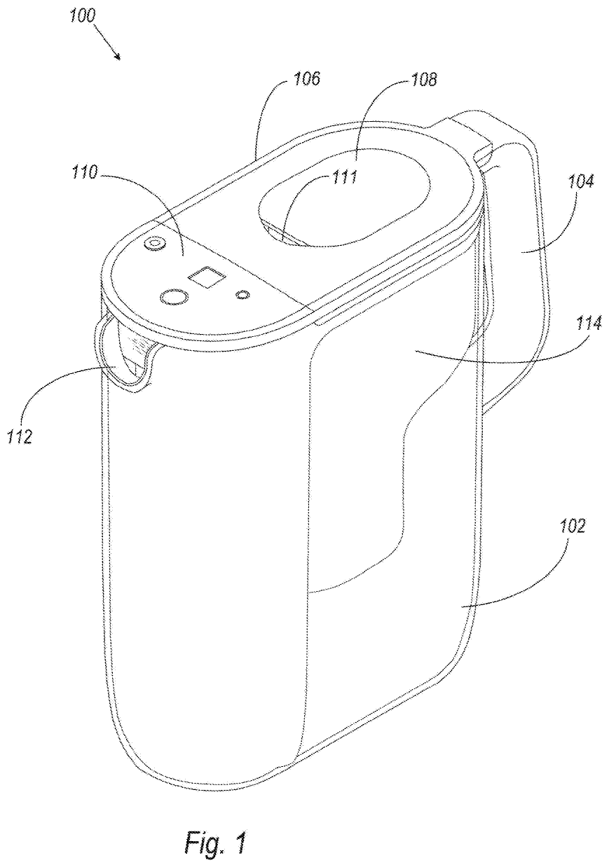

FIG. 1 is a general view of a water treatment pitcher, according to some embodiments of the present invention.

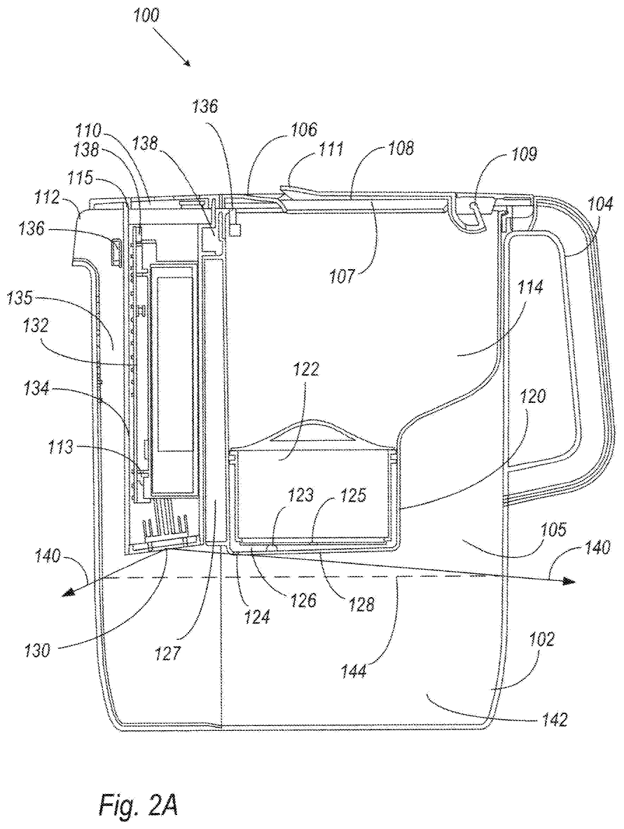

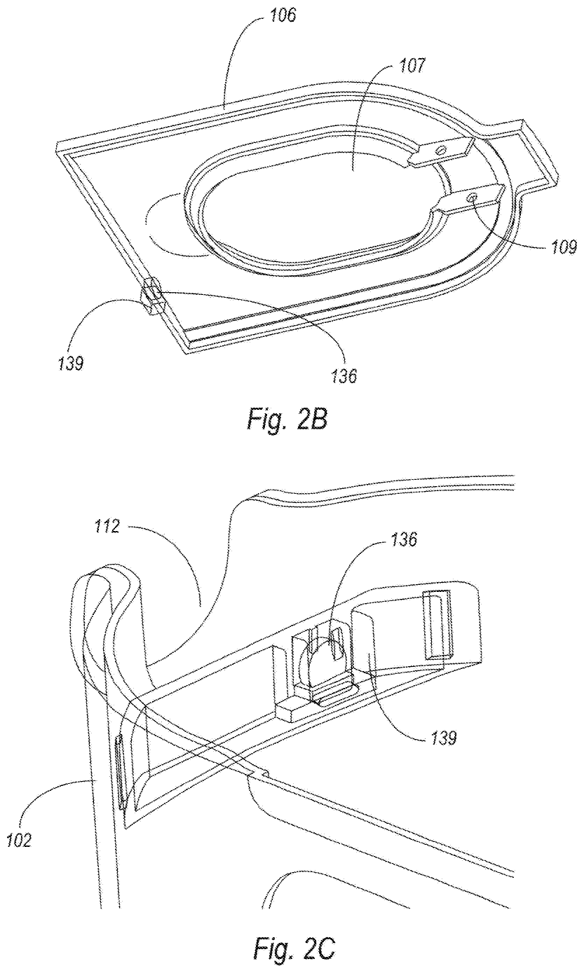

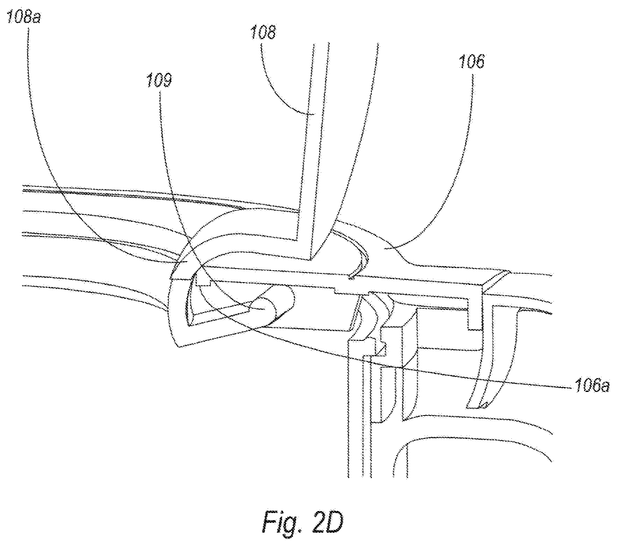

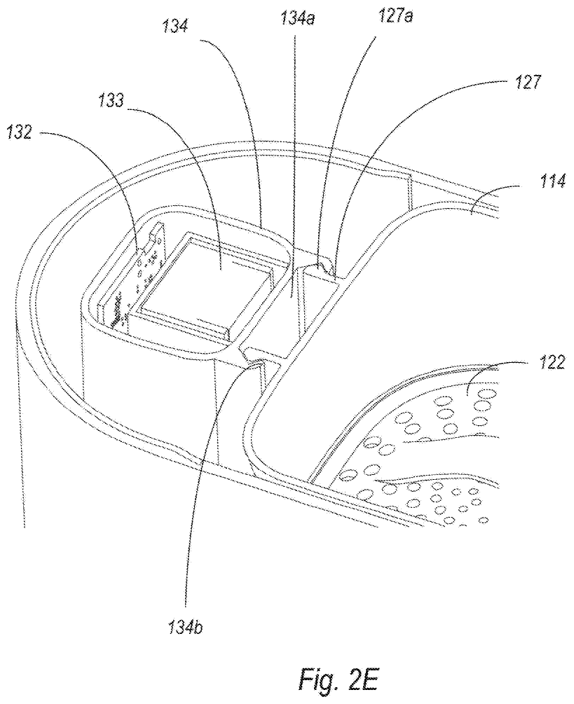

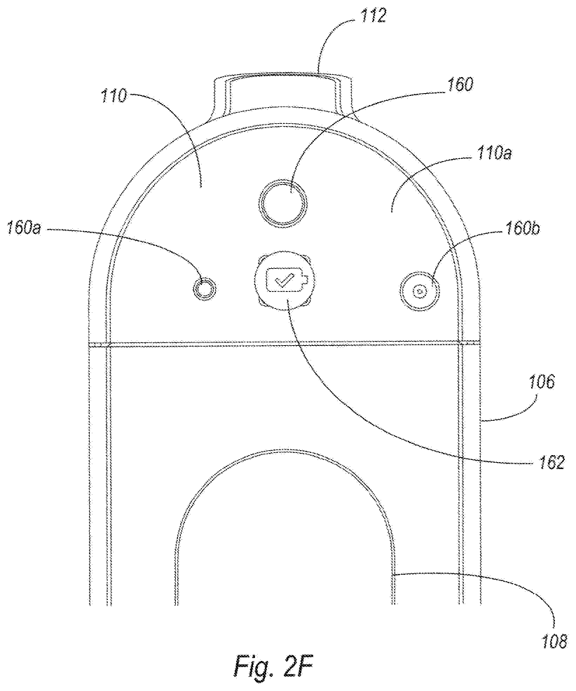

Water treatment pitcher (hereinafter, sometimes also “water pitcher” or “pitcher”) 100 includes a portable container 102, and may include a handle 104 to be gripped by a user and carried around. An upper water basin 114 may be provided within container 102, for receiving a replaceable filter and for draining filtered water into a lower portion of the container 102 below the upper water basin 114, where the filtered water is collected, until it is poured out of the pitcher through spout 112. Pitcher 100 may also include a cover 106 over a top opening of container 102. Cover 106 may include a filling lid 108, covering filling inlet 107 (see FIG. 2) for filling water into the upper water basin in order to filter it. Filing lid may be pivotally operated (see pivot 109, FIG. 2), to lift the lid open, or to lower the lid to a closed position.

A UV generator 110 (e.g., replaceable UV generator, for example, UV-c type generator) may also be inserted into the pitcher 100, through designed to generate UV light. UV light is used to expose living organisms, such as bacteria, viruses, or cysts (e.g., cryptosporidium, giardia, salmonella, E. Coli, streptococci, dysentery bacilli, Hepatitis B, etc.) to germicidal UV radiation. UV radiation (e.g., at 254 nm wavelength) may damage the DNA in pathogenic microorganisms to prevent their reproduction, thereby preventing bacteria from spreading disease through drinking water.

As UV radiation may be harmful to humans, according to some embodiments of the present invention the internal surfaces of the container bottom, side walls, and top cover) are made from material or materials, configured to prevent UV radiation transmission out of the pitcher (e.g., material that reflects or absorbs UV radiation). The container shown in FIG. 1 appears partially transparent—this is just to show internal parts in that figure, as a water treatment pitcher, according to some embodiments of the present invention is designed to prevent any UV radiation leakage from the pitcher.

UV generator may be configured to be removed or removable, for example, for charging or replacement, or to allow convenient cleaning of the pitcher. In some embodiments of the present invention, replacement may occur should the rechargeable battery fail to recharge.

FIG. 2A is a cross-sectional view of a water treatment pitcher, according to some embodiments of the present invention.

Filling lid 108 covers, when shut, filling inlet 107, through which water may be poured into upper water basin 114 of water treatment pitcher 100. Filter 122, may be fittingly placed in filter seat 120, supported on elevated filter supports 123 (e.g., bulges located on the basin floor 128, so that some gap 126 is left between the bottom of the filter 122 and the basin floor 128. In the described arrangement gravitational filtering takes place, as water poured into the upper water basin is forced by gravity to flow through filter 122. Filter 122, according to some embodiments of the present invention is configured to filter solid and/or dissolved contaminants (e.g., any insoluble solids). In some embodiments of the present invention, the filter is configured to perform chemical treatment on the water to be treated.

Floor 128 of the upper water basin 114 may be slightly inclined, so as to direct filtered water emerging from filter outlet 125 to flow over the inclined floor 128 to one or a plurality of basin outlet drip holes 124 located at the lower end of the inclined floor. Eventually, filtered water drips down into the lower space 105 of container 102 and is collected in the lower space 105, until it is dispensed out of the pitcher 100.

UV generator 110 may be fittingly inserted through an appropriate opening on top of the pitcher and maintained juxtaposed and coupled to column 127 located on a side wall substantially in front of container upper water basin 114 facing spout 112. The UV generator may be configured to be suspended, when properly positioned in place within the container, for example by providing one or more shoulders on which one or more top or ledge protruding laterally from the housing 134 of UV generator 110 may rest. The housing 134 of UV generator 110 may house a power source (e.g., rechargeable battery 133, see FIG. 2E), electronics 132 (e.g., printed circuit board, a controller, an interface, etc.) and UV light emitter 130 (e.g., a light emitting diode, LED, for example for emitting UVC (typically UV in the wavelength range of 200-280 nm), which is configured to produce and to emit a broad UV light beam 140 to illuminate laterally and down into lower space 105 (e.g., by producing a broad conical beam, having, for example, an illumination angle spanning up to 170 degrees), and onto the filtered water dripping from basin outlet 124, so as to effectively disinfect the dripping water, when water is dripping from outlet 124, and in the water that is in the lower space 105 of container 102. In some embodiments of the present invention, the UV generator is configured to be directed so as radiate UV radiation from the UV emitter onto the water collected in the lower space of the container (below the upper water basin) and/or to be directed so as to radiate the UV radiation onto the dripping water as it emerges from the outlet of the upper water basin.

In some embodiments the UV generator may be configured to radiate UV radiation only when installed inside the pitcher and when the cover fully covers the top opening of the container.

The UV emitter 130 may be configured to be operated continuously, intermittently, periodically, or at determined times. Various standards and regulations govern the manner in which UV radiation is administered in water treatment, requiring UV radiation for water treatment to be in a predetermined wavelength, or a range of wavelengths, generate minimal UV radiation energy, and be applied at a minimal duration of UV radiation, and according to some embodiments of the present invention, the UV generator is configured to comply with such standards and regulations.

In sonic embodiments of the present invention, the UV generator is configured to have a predetermined length such that the UV emitter is placed substantially at the same height level of the basin outlet 124, and upper water basin 114 is configured to contain a predetermined volume of water so that after it fully drains into the lower space 105 of container 102. the water level, when the container is maintained upright, does not reach or surpasses the height level of the UV emitter.

As UV radiation may be harmful, a safety disabling mechanism may be provided, to prevent the UV generator from generating UV radiation, when the UV generator is pulled out or when it is not properly positioned in an intended position within the pitcher. The safety disabling mechanism may include, for example, one or more pairs of a magnetic sensor, e.g., Hall Effect (HE) sensor 138 placed at the top of housing 134 of UV generator 110 and an opposite magnet 136, placed opposite to anticipated location of the HE sensor, when the UV generator is properly inserted in the pitcher and seated in position. The electronics 132. of UV generator 110 may be configured to detect when the magnet 136 and the HE sensor 138 are located opposite each other, within an allowed range, indicating proper positioning of the UV generator in place, thus allowing the UV emitter to emit UV light, and prevent the UV emitter from emitting UV light, when the magnet and the corresponding HE sensor are no longer in the allowed range, indicating that the UV generator is not properly inserted and seated in position within the pitcher 100. According to some embodiments of the present invention, other designs of safety mechanisms may be used, including, for example, a direct contact sensor, an optical sensor, a switch, or any other device or arrangement, for sensing and verifying that the cover and the UV generator are properly placed and in the right position.

In some embodiments of the present invention, the UV generator, when properly inserted in the pitcher and seated in position is configured to block any stray UV rays from escaping the pitcher through spout 112. In order to achieve this, the UV emitter is configured to generate a UV beam which is directed in a predefined confining angle downwards into the lower space of the container, whereas the housing of the UV generator is designed in a bulky design, e.g., having a bulky elongated body, such as, an elongated case, bar, cylinder, or having any other geometric properties that block any direct or reflected UV ray that is radiated from the UV emitter from escaping through spout 112.

FIG. 2B shows the cover 106 of a water treatment pitcher 100, according to some embodiments of the present invention, with a magnet holder 139 holding a magnet 136 of a safety disabling mechanism. The UV generator 110 may be designed to have an HE sensor 138 (see FIG. 2A), corresponding to the magnet, located in a position directly opposite that magnet.

FIG. 2C is a partial view of the spout area of a water treatment pitcher, according to some embodiments of the present invention, with another magnet holder 139, located below spout 112, inside container 102, to hold a magnet 136 of a safety disabling mechanism. UV generator 110 may include an HE sensor 138 (see FIG. 2A), corresponding to magnet 136 located in a position directly opposite that magnet.

FIG. 2D illustrates details of the filling lid 108 of a cover 106 of a water treatment pitcher, according to some embodiments of the present invention.

Filling lid 108 may pivotally swing from a generally horizontal closed position to a generally vertical open position, by flipping up filling lid 108 rotatable about pivot 109 e.g., by using a finger to hold and raise protruding tab 111 of filling lid 108. In order to facilitate convenient filling of the upper water basin with tap water, filling lid may be kept at an upright position, by providing a knee-shaped end 108a to filling lid 108, which when swung up is stopped by stopper edge 106a of cover 106. When the pitcher is filled the user may rotate filling lid 108 back to its closed position.

FIG. 2E is a partial top view through the top opening into the container of a water treatment pitcher, according to some embodiments of the present invention.

Column 127 may include elongated protrusions 127a extending laterally alongside column 127 on opposite sides, while the housing 134 may include a matching groove 134a extending along the elongated axis of the housing and having narrowing groove lips 134b, configured to fit over column 127, such that when the UV generator is installed in position within the pitcher, the UV generator housing is slidingly engageable, e.g., slidingly linked to column 127 by inserting it into the groove 134a and sliding the UV housing over the column to its desired position.

FIG. 2F is a partial top view a cover 106 of a water treatment pitcher, according to some embodiments of the present invention, with the UV generator inserted in position inside the pitcher.

The top surface 110a of UV generator 110 may include one or more operating buttons, 160, 160a for operating one or more functionalities (e.g., manual/auto, reset, etc.) of the UV generator. The top surface 110a of UV generator 110 may also include a display screen 162, for displaying various operational indications, such as, for example, battery charging status (e.g., power indicator), identifying work stage (filtering, UV purifying), notifications (e.g., maintenance required, filter to be replaced, UV generator to be replaced, etc.).

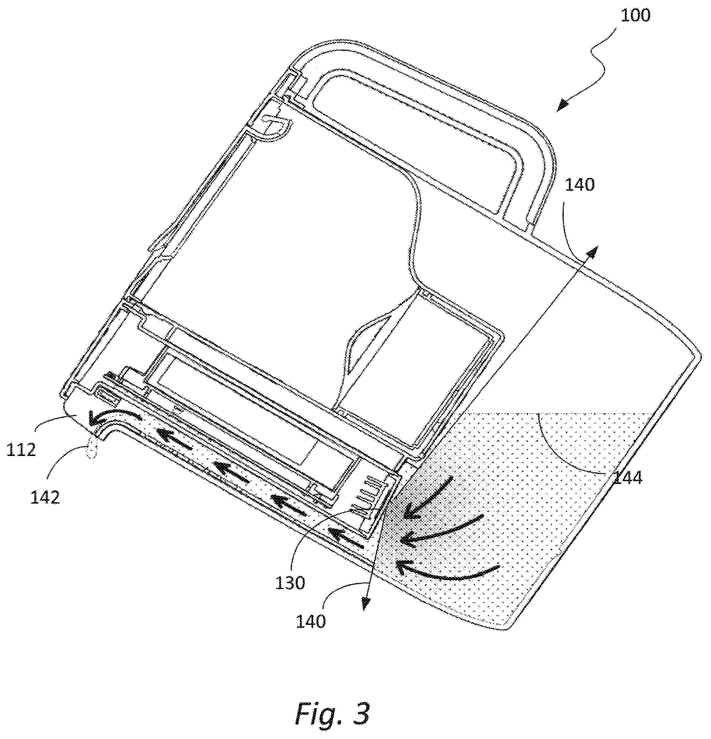

FIG. 3 illustrates dispensing filtered water from the water treatment pitcher 100, according to some embodiments of the present invention.

Pitcher 100 may be held and lifted by its handle 104 and tilted until the water level 144 within the lower space 105 of container 102 levels with spout 112, so as to allow filtered and UV treated water from within the lower space 105 of container 102 to be poured out and dispensed 142 through spout 112.

In some embodiments of the present invention, the shape and location of the upper water basin 114 and the juxtaposed UV generator 110 within the pitcher may be designed so as to define a narrow passage 135 (see FIG. 2A) from within the lower space of container 102 towards spout 112, having an inlet adjacent to the UV emitter 130 and an outlet adjacent to spout 112.

When pouring water from the pitcher the UV generator may be used to radiate UV into the water as it flows near the UV emitter 130 towards spout 112.

In some embodiments of the present invention, the UV generator may be configured to emit UV light during the pouring action. A tilt sensor 113 may be used to detect when the pitcher 100 is tilted, and the UV generator 110 may be configured, based on this detection, to operate the UV emitter 130 to radiate UV onto the water while it is dispensed from spout 112. In some embodiments the user may activate the UV generator by pressing on an operating button e.g., 160, 160a, see FIG. 2F)

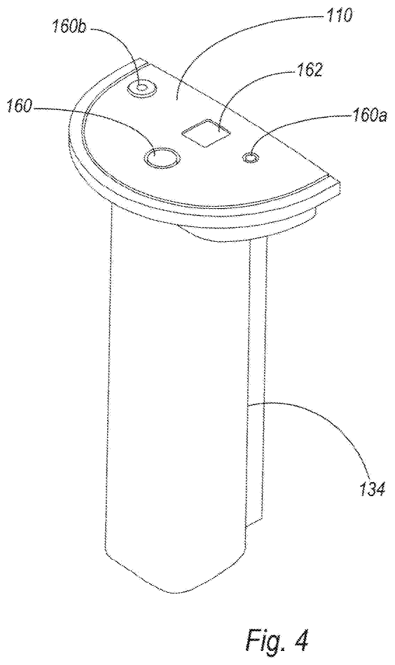

FIG. 4 illustrates an ultraviolet (UV) generator for use in a filter pitcher, according to some embodiments of the present invention.

Housing 134 of UV generator 110 may include a charging port for charging a rechargeable power source of the UV generator 110, e.g., a USB socket for plugging a. plug of a charger cord and facilitate the charging, a magnetic charging connector 160b (see FIG. 2F), or other type of charging port.

Following is an index of elements shown in the figures:
100-pitcher;
102-container;
104-handle;
105-lower space of container 102.
106-cover;
106a-stopper edge;
107-filling inlet;
108-filling lid;
108a-knee-shaped end;
109-lid pivot;
110-UV generator;
110a-top surface;
111-protruding tab;
112-spout;
113-tilt sensor;
114-upper water basin;
120-filter seat;
122-replaceable filter;
123-elevated filter support;
124-basin outlet;
125-filter outlet;
126-gap;
127-column;
127a-elongated protrusion;
128-basin floor;
130-UV light emitter;
132-electronics;
133-rechargeable battery;
134-UV housing;
134a-groove;
134b-narrowing groove lips;
135-passage;
136-magnet;
138-Hall Effect sensor;
139-magnet holder;
140-UV light beam;
142-dispensed water;
144-water level;
160, 160a-operating buttons;
160b-magnetic charging connector;
162-display.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A water treatment pitcher comprising:
a portable container, with a cover to cover a top opening of the container, the cover comprising a filling inlet, the container having a spout for dispensing filtered water;
an upper water basin inside the portable container for receiving water introduced through the filling inlet, having a filter seat to accommodate a filter, to filter water in the water basin, the water basin configured to allow the filtered water to drip into and be collected in a space of the container that is lower with respect to the filter when the container is upright; and
an ultraviolet (UV) generator configured to radiate UV radiation from a UV emitter on the water collected in the space and to radiate UV radiation from the UV emitter onto the filtered water as it drips from an outlet of the upper water basin to the space of the container that is lower with respect to the filter.

2. The water pitcher of claim 1, further comprising a tilt sensor, and wherein the UV generator is further configured to radiate UV radiation from the UV emitter when the tilt sensor detects that the pitcher is tilted.

3. The water pitcher of claim 1, wherein shape and position of the upper water basin and the UV when placed within the pitcher define a passage from within the space of container towards the spout, having an inlet adjacent to the UV emitter and an outlet adjacent to the spout.

4. The water pitcher of claim 1, wherein the UV generator is configured to radiate UV radiation only when installed inside the pitcher and when the cover fully covers the top opening of the container.

5. The water treatment pitcher of claim 1, wherein the UV generator, when installed inside the pitcher, is juxtaposed to the water basin.

6. The water treatment pitcher of claim 1, wherein the cover is removable.

7. The water treatment pitcher of claim 1, wherein the filter is replaceable.

8. The water treatment pitcher of claim 1, further comprising a safety disabling mechanism to disable the UV generator from generating UV radiation when the UV generator is not positioned in an intended position inside the pitcher.

9. The water treatment pitcher of claim 8, wherein the safety disabling mechanism includes at least one pair of a magnetic sensor and a magnet.

10. The water treatment pitcher of claim 9, wherein the magnetic sensor is a Hall Effect sensor.

11. The water treatment pitcher of claim 1, wherein the UV generator is slidingly engageable to a side wall of the water basin.

12. The water treatment pitcher of claim 11, wherein the UV generator comprises an elongated housing with a groove and the side wall of the water basin comprises a column, and wherein the groove is configured to fit over the column.

13. The water treatment pitcher of claim 1, further comprising a display for displaying one or a plurality of indications.

14. The water treatment pitcher of claim 13, wherein the display is located on a top surface of the UV generator.

15. The water treatment pitcher of claim 1, wherein the UV generator comprises a. rechargeable battery.

16. The water treatment pitcher of claim 14, wherein the UV generator comprises a charging port.

17. The water treatment pitcher of claim 16, wherein the charging port comprises a USB socket or a magnetic charging connector.
